(19) United States
(12) Patent Application Publication
(10) Pub. No.: US 2019/0317809 A1
(43) Pub. Date: Oct. 17, 2019

(54) IMPLEMENTATION METHOD AND APPARATUS OF TIMER

(71) Applicant: SHENZHEN GOODIX TECHNOLOGY CO., LTD., SHENZHEN (CN)

(72) Inventors: MING ZHU, SHENZHEN (CN); MINGLIANG WANG, SHENZHEN (CN); GUOCHAO YIN, SHENZHEN (CN); LIHUA HU, SHENZHEN (CN)

(21) Appl. No.: 16/454,011

(22) Filed: Jun. 26, 2019

Related U.S. Application Data
(63) Continuation of application No. PCT/CN2018/072867, filed on Jan. 16, 2018.

(51) Int. Cl. G06F 9/48; G06F 1/14

(52) U.S. Cl. CPC G06F 9/4887; G06F 1/14

(57) ABSTRACT

The present disclosure provides an implementation method and apparatus of timer, the method includes: determining a counting period of a hardware timer according to expiration time of a timer node expires first in a timer linked list; and when the counting period of the hardware timer is expired, traversing through the timer node in the timer linked list and updating the counting period of the hardware timer. The present disclosure provides a technical solution that can effectively reduce system power consumption and processor resource occupancy.

### CROSS-REFERENCE TO RELATED APPLICATIONS

This application is a continuation of International Application No. PCT/CN2018/072867, filed on Jan. 16, 2018, the disclosure of which is hereby incorporated by reference in its entirety.

### TECHNICAL FIELD

The present disclosure relates to the technical field of embedded system timer, and in particular, to an implementation method and apparatus of timer.

### BACKGROUND

In an embedded system, timers are often used. With the increasing demand for timing functions in applications and the need for timeout mechanisms for processor peripheral modules, the demand for the number of timers is growing. However, the number of hardware timers is limited, so more timers are needed to be provided according to software solution.

The software timer scheme adopted by the embedded real-time operating system FreeRTOS is, at present, a commonly used software timer implementation scheme. The FreeRTOS implements software timers as the following: creating a timer linked list, into which a new timer will be added when the timer is being created; creating a daemon when the timer linked list is created, the daemon looping through the timers in the timer linked list at a given interval to determine whether a timer is expired, and executing a corresponding scheduled task when a timer has indeed expired.

However, the above-mentioned software timer implementation of continuously querying the software timer linked list for a timer that is expired will lead to added system power consumption.

### SUMMARY

In view of the above, the present disclosure provides an implementation method and apparatus of timer for reducing system power consumption.

For the purpose of achieving the above objectives, in a first aspect, the present disclosure provides an implementation method of timer, including:

determining a counting period of a hardware timer according to expiration time of a timer node expires first in a timer linked list; and

when the counting period of the hardware timer is expired, traversing through the timer node in the timer linked list and updating the counting period of the hardware timer.

By determining the counting period of the hardware timer according to the expiration time of the timer node expires first in the timer linked list, and when the counting period of the hardware timer is expired, traversing through the timer node in the timer linked list and updating the counting period of the hardware timer, the traversing through the timer linked list is performed only when a timer node is expired, thus no need to constantly traverse through the timer linked list. Therefore, the system power consumption and processor resource occupancy can be effectively reduced. Moreover, since the counting period of the hardware timer is updated in real time according to the expiration time of the timer node expires first in the timer linked list, the accuracy of the software timer is not affected by the counting period of the hardware timer because the accuracy of the software timer is equivalent to the accuracy of the hardware timer. Therefore, the accuracy of the software timer can be effectively improved.

As an alternative implementation of the embodiment of the present disclosure, the updating the counting period of the hardware timer includes:

determining whether the timer linked list is empty and,

if the timer linked list is empty, updating the counting period of the hardware timer with a maximum counting period of the hardware timer;

if the timer linked list is not empty, obtaining the expiration time of the timer node expires first in the timer linked list and current system time;

determining whether a time interval between the expiration time of the timer node expires first and the current system time is greater than the maximum counting period of the hardware timer and,

if the time interval is greater than the maximum counting period of the hardware timer, updating the counting period of the hardware timer with the maximum counting period of the hardware timer;

if the time interval is less than or equal to the maximum counting period of the hardware timer, updating the counting period of the hardware timer with the time interval.

By determining whether the time interval between the expiration time of the timer node expires first and the current system time is greater than the maximum counting period of the hardware timer, and updating the counting period of the hardware timer with the maximum counting period of the hardware timer when the time interval is greater than the maximum counting period of the hardware timer, the problem of the hardware timer count overflow can be solved. By updating the counting period of the hardware timer to a time interval when the time interval is less than or equal to the maximum counting period of the hardware timer, it is possible to only traverse through the timer linked list when a timer node is expired in the timer linked list, reducing system power consumption.

As an alternative implementation of the embodiment of the present disclosure, each timer node in the timer linked list is sorted according to their expiration time.

Sorting the timer nodes in the timer linked list according to their expiration time facilitates operations such as searching and traversing for the timer linked list, improving the processing speed.

As an alternative implementation of the embodiment of the present disclosure, the traversing through the timer node in the timer linked list and updating the counting period of the hardware timer includes:

setting a first timer node in the timer linked list to be a current timer node, and performing traversing operation on the current timer node, the traversing operation including:

obtaining current system time;

determining whether the current timer node is not empty and the current system time is greater than or equal to the expiration time of the current timer node and,

updating the counting period of the hardware timer if the current timer node is empty or the current system time is less than the expiration time of the current timer node;

if the current timer node is not empty and the current system time is greater than or equal to the expiration time of the current timer node, executing a callback function of the current timer node; and

setting a next timer node in the timer linked list to be the current timer node, and returning to perform the traversing operation.

When traversing through the timer linked list, the current system time is firstly obtained, and expired timer node are identified according to the current system time, so that the scheduled tasks of the timer node with similar expiration times can be processed in time to reduce the system delay.

As an alternative implementation of the embodiment of the present disclosure, after the executing a callback function of the current timer node, the method further includes:

determining whether the current timer node is a periodic timer and,

if the current timer node is a periodic timer, updating the expiration time of the current timer node, and setting an update flag of the linked list to True;

if the current timer node is a one-time timer, deleting the current timer node;

when the current timer node is empty or the current system time is less than the expiration time of the current timer node, then before updating the counting period of the hardware timer, the method further includes:

determining whether the update flag of the linked list is set to be True; and

updating ordering of the timer linked list if the update flag of the linked list is set to be True.

By setting the update flag of the linked list, it is possible to avoid missing out on timer node during the traversing, improving the accuracy of the software timer.

As an alternative implementation of the embodiment of the present disclosure, the method may further include:

inserting a new timer node into the timer linked list; and

when the new timer node is the first node in the timer linked list, updating the counting period of the hardware timer.

When a new timer node created in the timer linked list is the first node in the timer linked list, the counting period of the hardware timer is updated, guaranteeing the correct order of processing the timer node in the timer linked list.

As an alternative implementation of the embodiment of the present disclosure, the inserting a new timer node into the timer linked list specifically includes:

obtaining a timing duration of a timer node to be created and current system time;

calculating expiration time of the timer node to be created according to the timing duration of the timer node to be created and the current system time; and

inserting the timer node to be created as a new timer node into the timer linked list according to the expiration time of the timer node to be created.

As an alternative implementation of the embodiment of the present disclosure, the method further includes:

when a software timer is turned off, deleting a timer node corresponding to the turned off software timer from the timer linked list; and

when the deleted timer node is a first node in the timer linked list, updating the counting period of the hardware timer.

When a timer node deleted from the timer linked list is the first node in the timer linked list, the counting period of the hardware timer is updated, guaranteeing the correct order of processing the timer nodes in the timer linked list.

As an alternative implementation of the embodiment of the present disclosure, when the counting period of the hardware timer is expired and before the traversing through a timer node in the timer linked list, the method further includes:

updating system time with the expiration time of the counting period of the hardware timer.

When the counting period of the hardware timer is expired, before the timer node in the timer linked list is traversed, the system time is updated with the expiration time of the counting period of the hardware timer, so that the timer linked list and the system timing may share a common hardware timer without affecting system timing.

In a second aspect, an embodiment of the present disclosure provides an implementation apparatus of timer, including: a determining module, a traversing module and a timer updating module, where

the determining module is configured to determine a counting period of a hardware timer according to expiration time of a timer node expires first in a timer linked list;

the traversing module is configured to, when the counting period of the hardware timer is expired, traverse through a timer node in the timer linked list, and instruct the timer updating module to update the counting period of the hardware timer.

As an alternative implementation of the embodiment of the present disclosure, the timer updating module includes:

a determining unit, configured to determine whether the timer linked list is empty;

an updating unit, configured to update the counting period of the hardware timer with a maximum counting period of the hardware timer when the timer linked list is empty;

a first obtaining unit, configured to obtain the expiration time of the timer node expires first in the timer linked list and current system time when the timer linked list is not empty;

the determining unit is further configured to determine whether a time interval between the expiration time of the timer node expires first and the current system time is greater than the maximum counting period of the hardware timer; and

the updating unit is further configured to update the counting period of the hardware timer with the maximum counting period of the hardware timer when the time interval is greater than the maximum counting period of the hardware timer, and update the counting period of the hardware timer with the time interval when the time interval is less than or equal to the maximum counting period of the hardware timer.

As an alternative implementation of the embodiment of the present disclosure, each timer node in the timer linked list is sorted according to their expiration time.

As an alternative implementation of the embodiment of the present disclosure, the traversing module is specifically configured to:

set a first timer node in the timer linked list to be a current timer node, and perform traversing operation on the current timer node, the traversing operation comprising:

obtaining current system time;

determining whether the current timer node is not empty and the current system time is greater than or equal to the expiration time of the current timer node and,

updating the counting period of the hardware timer if the current timer node is empty or the current system time is less than the expiration time of the current timer node;

if the current timer node is not empty and the current system time is greater than or equal to the expiration time of the current timer node, executing a callback function of the current timer node; and

setting a next timer node in the timer linked list to be the current timer node, and returning to perform the traversing operation.

As an alternative implementation of the embodiment of the present disclosure, the traversing module is further configured to:

determine whether the current timer node is a periodic timer, and

if the current timer node is a periodic timer, instruct the timer updating module to update the expiration time of the current timer node, and set an update flag of the linked list to True;

if the current timer node is a one-time timer, delete the current timer node;

the traversing module is further configured to: determine whether the update flag of the linked list is set to be True when the current timer node is empty or the current system time is less than the expiration time of the current timer node, and before updating the counting period of the hardware timer; and

update ordering of the timer linked list if the update flag of the linked list is set to be True.

As an alternative implementation of the embodiment of the present disclosure, the apparatus further includes:

a node creating module, configured to insert a new timer node into the timer linked list; and

the node creating module is further configured to, when the new timer node is the first node in the timer linked list, update the counting period of the hardware timer.

As an alternative implementation of the embodiment of the present disclosure, the node creating module specifically includes:

a second obtaining unit, configured to obtain a timing duration of a timer node to be created and current system time;

a calculating unit, configured to calculate expiration time of the timer node to be created according to the timing duration of the timer node to be created and the current system time; and

an inserting unit, configured to insert the timer node to be created as a new timer node into the timer linked list according to the expiration time of the timer node to be created.

As an alternative implementation of the embodiment of the present disclosure, the apparatus further includes:

a deleting module, configured to, when a software timer is turned off, delete a timer node corresponding to the turned off software timer from the timer linked list; and

the deleting module is further configured to: when the deleted timer node is a first node in the timer linked list, update the counting period of the hardware timer.

As an alternative implementation of the embodiment of the present disclosure, the apparatus further includes: a system time updating module, configured to, when the counting period of the hardware timer is expired and before traversing through the timer node in the timer linked list, update system time with the expiration time of the counting period of the hardware timer.

For the beneficial effects from the implementation apparatus of timer provided by the above second aspect and various possible implementations thereof, reference may be made to the beneficial effects from the first aspect and various possible implementations thereof, which will not be repeated herein.

### BRIEF DESCRIPTION OF THE DRAWINGS

FIG. 1 is a schematic flowchart of an implementation method of timer according to an embodiment of the present disclosure;

FIG. 2 is a schematic flowchart of a method for updating a counting period of a hardware timer according to an embodiment of the present disclosure;

FIG. 3 is a schematic flowchart of another implementation method of timer according to an embodiment of the present disclosure;

FIG. 4 is a schematic flowchart diagram of still another implementation method of timer according to an embodiment of the present disclosure;

FIG. 5 is a schematic flowchart of a method for inserting a new timer node in a timer linked list according to an embodiment of the present disclosure;

FIG. 6 is a schematic flowchart of still another implementation method of timer according to an embodiment of the present disclosure;

FIG. 7 is a schematic structural diagram of an implementation apparatus of timer according to an embodiment of the present disclosure; and

FIG. 8 is a schematic structural diagram of another implementation apparatus of timer according to an embodiment of the present disclosure.

### DETAILED DESCRIPTION OF THE EMBODIMENTS

The technical solution of the present disclosure is described in detail below with reference to the accompanying drawings.

In order to meet the demand for more timers, in the related art, a solution implements software timers as the following: creating a daemon when a timer linked list is created, the daemon looping through the timers in the timer linked list at a given interval to determine whether a timer is expired, and executing a corresponding scheduled task when a timer has indeed expired. In this solution, when the timer has a short timing duration, it is necessary to traverse through the timer linked list with a smaller time interval. In this way, the daemon needs to traverse through the timer linked list very frequently, leading to significant system power consumption as well as more processor resource being occupied. Moreover, the interval at which the daemon traverses through the timer linked list determines the accuracy of the software timer. When the timing duration of the timer in the timer linked list is shorter than the interval, the timer may have an increased error if it is executed. Therefore, the software timer implementation will greatly reduce the accuracy of the software timer.

Based on this, an embodiment of the present disclosure provides an implementation method and apparatus of timer, which act mainly by determining the counting period of the hardware timer according to the expiration time of the timer node expires first in the timer linked list. When the hardware timer counting period is expired and after traversing through the timer node in the timer linked list, the counting period of the hardware timer is updated instantly to reduce the number of times the timer linked list being traversed through, reducing system power consumption and processor resource occupancy rate while improving the accuracy of the software timer.

The implementation method and apparatus of timer provided by the embodiment of the present disclosure can be applied to various embedded systems or related products provided with timing service requirements. In addition, the method does not require support from the operating system, and can be applied to embedded systems with or without an operating system.

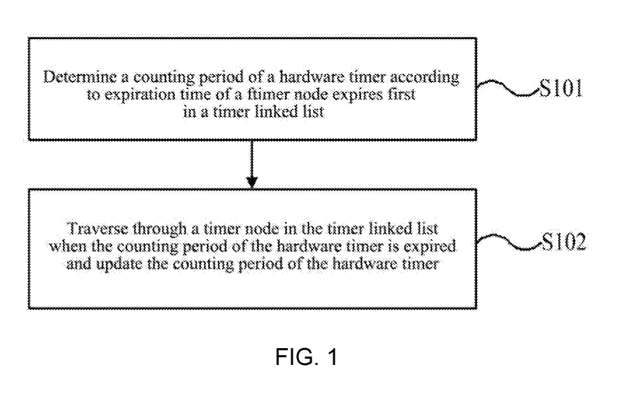

FIG. 1 is a schematic flowchart of an implementation method of timer according to an embodiment of the present disclosure, the execution body of the method may be an implementation apparatus of timer or an embedded system integrated with an implementation apparatus of timer, As shown in FIG. 1, the method provided in the embodiment includes the following steps:

S101, determine a counting period of a hardware timer according to an expiration time of a timer node expires first in a timer linked list.

Specifically, the timer linked list is created according to the scheduled task requirement, hence a timer node in the timer linked list corresponds to a scheduled task that the system needs to handle. Each hardware timer in the system can maintain a timer linked list, that is, the timer node in each timer linked list share a common hardware timer.

Each scheduled task has a timing duration. When a timer node is created, the absolute time which the timer node reaches firstly, i.e., the expiration time of the timer node, can be calculated according to the timing duration of the scheduled task and current system time.

The timer node in the timer linked list can store information such as timer name, timing duration, expiration time, timing mode (including one-time timer and periodic timer), and callback function.

When the hardware timer is at work, it interrupts counting at certain intervals, and restarts counting when the counting period is reached. Hardware timers have a maximum counting period based on hardware characteristics of hardware timers.

In the embodiment, after the timer linked list is created, the counting period of the hardware timer is determined according to the expiration time of the timer node expires first in the timer linked list.

Specifically, when the time interval between the expiration time of the timer node expires first and the current system time is less than or equal to the maximum counting period of the hardware timer, the time interval can be used as the counting period of the hardware timer. When the time interval between the expiration time of the timer node expires first and the current system time is greater than the maximum counting period of the hardware timer, the maximum counting period of the hardware timer can be used as the counting period of the hardware timer.

In order to facilitate the operations, e.g., lookup and traversing, on the timer linked list and improve the processing speed, in this embodiment, each timer node in the timer linked list may be sorted according to their expiration time. At this point, the first timer node in the timer linked list is the timer node expires first. For convenience of description, the technical solutions of the embodiments of the present disclosure will also be described below by taking as an example each timer node in the timer linked list being sorted according to their expiration time.

S102, when the counting period of the hardware timer is expired, traverse through a timer node in the timer linked list and update the counting period of the hardware timer.

Specifically, when a counting period of a hardware timer is expired, which indicates that the first timer node in the timer linked list is expired, an interrupt service program can now be started to begin from the first timer node in the timer linked list to sequentially traverse through the timer node in the timer linked list, until the expired timer node is located, and the corresponding scheduled task is executed, that is, the callback function of the expired timer node is executed.

For a timer node whose timing mode is a one-time timer, the timer node is deleted after executing the corresponding callback function. For a timer node whose timing mode is a periodic timer, after executing the corresponding callback function, the time of the next expiration is updated for the timer node, and the timer node is inserted into the timer linked list by its order of expiration.

When traversing to an unexpired timer node or the end of the timer linked list, the counting period is updated for the hardware timer, that is, the counting period of the hardware timer is determined according to the expiration time of the first timer node in the traversed timer linked list. When the counting period of the hardware timer is expired, that is, when the next timer node is expired, the timer linked list is traversed again.

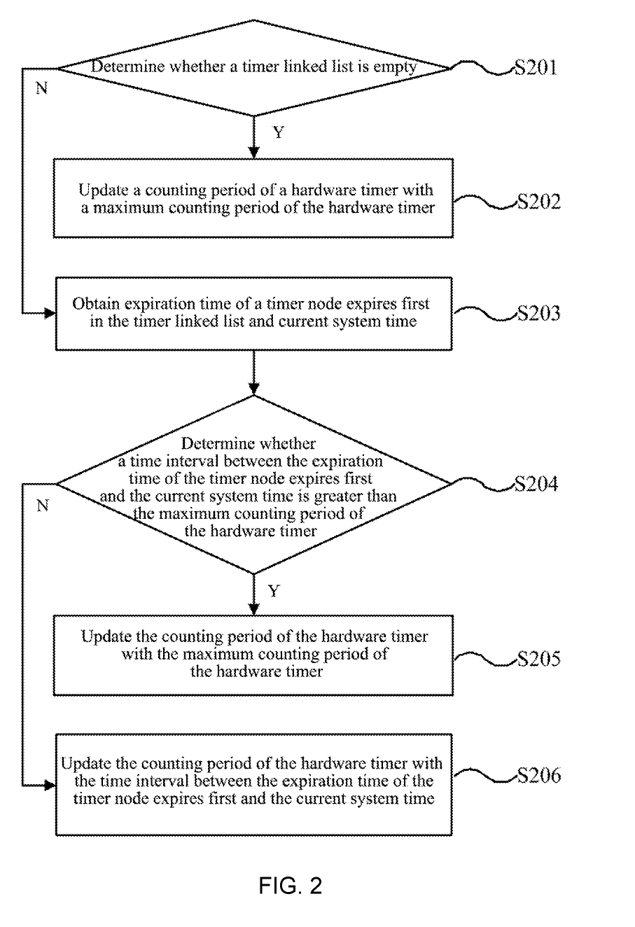

FIG. 2 is a schematic flowchart of a method for update a counting period of a hardware timer according to an embodiment of the present disclosure, as shown in FIG. 2, the updating the counting period of the hardware timer can be implemented as the following:

S201, determine whether a timer linked list is empty and, if yes, execute step S202, otherwise, execute step S203.

Specifically, after the first timer node in the timer linked list is expired and the traversing of the timer linked list is completed, the timer linked list may be empty or not empty.

When the timer linked list is not empty, the counting period of the hardware timer is determined according to the expiration time of the timer node expires first in the timer linked list. When the timer linked list is empty, the counting period of the hardware timer can be set arbitrarily.

S202, update a counting period of a hardware timer with a maximum counting period of the hardware timer.

In the embodiment, when the timer linked list is empty, the counting period of the hardware timer is updated with the maximum counting period of the hardware timer, so as to reduce the number of hardware timer interrupts as well as system power consumption and processor resource occupancy rate.

S203, obtain expiration time of a timer node expires first in the timer linked list and current system time.

When the timer linked list is not empty, the counting period of the hardware timer is determined according to the expiration time of the timer node expires first in the timer linked list. In this case, it is necessary to obtain the expiration time of the timer node expires first in the timer linked list and the current system time, so as to determine the counting period of the hardware timer according to the two obtained times.

S204, determine whether a time interval between the expiration time of the timer node expires first and the current system time is greater than the maximum counting period of the hardware timer and, if yes, execute step S205, otherwise, execute step S206.

Specifically, the timing duration may vary in length for individual timer node in the timer linked list. When the timing period of the timer node expires first is too long, the time interval between the expiration time and the current system time (that is, the difference between the expiration time of the timer node expires first and the current system time) may exceed the maximum counting period of the hardware timer, leading to overflow in the count of the hardware timer because the maximum counting period of the hardware timer has to be the maximum counting period. When the timing duration of the timer node expires first is relatively short, the counting period of the hardware timer can be directly set to be the time elapsed when the timer node is expired.

S205, update the counting period of the hardware timer with the maximum counting period of the hardware timer.

Specifically, when the time interval between the expiration time of the timer node expires first and the current system time is greater than the maximum counting period of the hardware timer, the counting period of the hardware timer can be updated with the maximum counting period of the hardware timer. When the counting period of the hardware timer expires again, the counting period is re-updated for the hardware timer according to the expiration time of the first timer node in the timer linked list.

S206, update the counting period of the hardware timer with the time interval between the expiration time of the timer node expires first and the current system time.

Specifically, when the time interval between the expiration time of the timer node expires first and current system time is less than or equal to the maximum counting period of the hardware timer, the counting period of the hardware timer is updated with the time interval. When the counting period of the hardware timer expires again, the timer node expires first is expired, and then the timer linked list is traversed again.

In this embodiment, the timer linked list may share a hardware timer with the system timing. In the specific implementation, when the counting period of the hardware timer expires, the system time may be updated with the expiration time of the counting period of the hardware timer before traversing through the timer node in the timer linked list.

The system time is based on the count timing of the hardware timer. When the system time is timed using a separate hardware timer, the current system time is obtained by accumulating the time elapsed until the current count of the hardware timer on the basis of the system time when the hardware timer last reached its maximum counting period (that is, the product of the count of the hardware timer and the counting interval).

In the embodiment, each time the counting period of the hardware timer expires, the system time is firstly updated with the expiration time of the counting period of the hardware timer. Thus, the timer linked list can share a hardware timer with the system timing without affecting the system timing.

According to the implementation method of timer provided by the embodiment, the counting period of the hardware timer is determined according to the expiration time of the timer node expires first in the timer linked list; when the counting period of the hardware timer expires, the timer node in the timer linked list are traversed through, and then the counting period is updated for the hardware timer. Therefore, it is possible to traverse through the timer linked list only when a timer node is expired, without any need to constantly traverse through the timer linked list. Therefore, the system power consumption and processor resource occupancy rate can be effectively reduced. Moreover, the counting period of the hardware timer is updated in real time according to the expiration time of the timer node expires first in the timer linked list. Thus, the accuracy of the software timer is not affected by the counting period of the hardware timer because the accuracy of the software timer is equivalent to the accuracy of the hardware timer. Therefore, the accuracy of the software timer can be effectively improved.

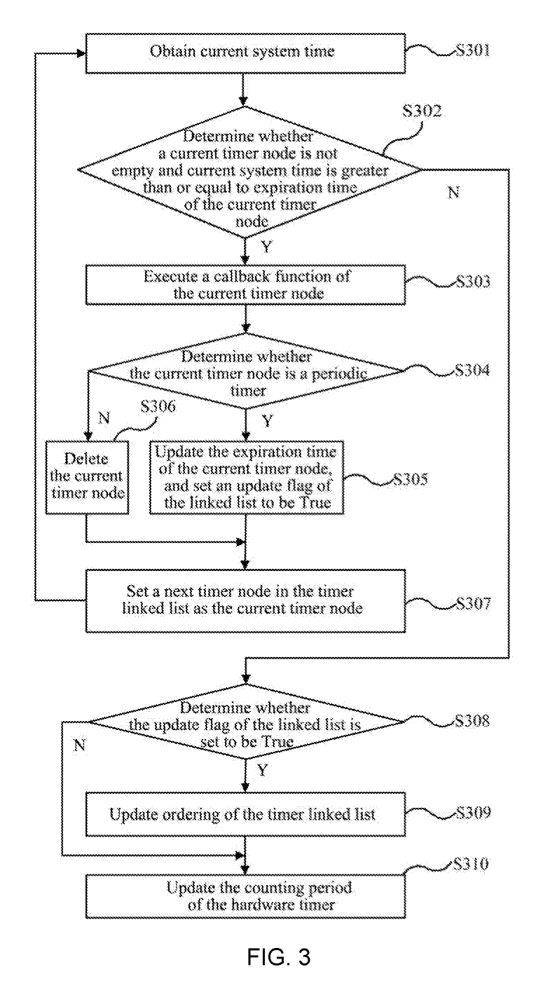

FIG. 3 is a schematic flowchart of another implementation method of timer according to an embodiment of the present disclosure. The embodiment is a specific implementation of step S102 in the above embodiment shown in FIG. 1. Based on the above embodiment shown in FIG. 1, as shown in FIG. 3, the timer node in the timer linked list is traversed, and the counting period is updated for the hardware timer in step S102 may specifically include the following.

The first timer node in the timer linked list is used as the current timer node, and a traversing operation is performed on the current timer node, the traversing operation includes the following.

S301, obtain current system time.

Specifically, the expiration times of the timer nodes in the timer linked list may be the same as, or very similar to, each other. When a timer node in the timer linked list has an expiration time close to an expiration time of the first timer node, a subsequent timer node with a similar expiration time may expire when the first timer node is still being processed. Then, this timer node with similar expiration time also needs to be processed during the traversing process.

Based on this, when a timer node has been reached during the process of traversing through the timer linked list, current system time is firstly obtained in order to find out all timer nodes that have expired in the timer linked list during the current traversing process using the current system time.

S302, determine whether a current timer node is not empty and current system time is greater than or equal to expiration time of the current timer node and, if yes, execute step S303, otherwise, execute step S308;

Specifically, when the traversing has reached a timer node, a check needs to be made to see if the traversing has reached the end of the timer linked list or a timer node that is yet to expire.

When the timer node reached during the traversing (i.e., the current timer node) is an expired timer node, the scheduled task of the current timer node is executed.

When the timer node reached during the traversing is an empty node, it indicates that the traversing has reached to the end of the timer linked list, and there is no need to continue the traversing. Each timer node in the timer linked list is sorted according to their expiration time. When the timer node reached during the traversing is an unexpired timer node, it indicates that none of the timer nodes that follow have expired, and there is again no need to continue the traversing.

S303, execute a callback function of the current timer node.

If the current timer node is not empty and the current system time is greater than or equal to the expiration time of the current timer node, the current timer node is an expired timer node. At this point, the callback function of the current timer node is executed to carry out the corresponding scheduled task.

S304, determine whether the current timer node is a periodic timer and, if yes, execute step S305, otherwise, execute step S306.

In the embodiment, after the callback function of the current timer node is executed, a determination can be made regarding whether the current timer node is a periodic timer. A one-time timer node is simply deleted after executing the callback function. A periodic timer node needs to have its expiration time being changed and then be inserted into the timer linked list according to its sequence of expiration time after the callback function is executed.

S305, update the expiration time of the current timer node, and set an update flag of the linked list to True.

Specifically, if the current timer node is a periodic timer, after the callback function of the current timer node is executed, the expiration time of the current timer node is updated with the time of the next expiration of the timer node, that is, the expiration time of the current timer node is updated with the sum of the timing duration of the timer node and the current system time.

In order to avoid compromising the order of traversing through the timer linked list, which may lead to missing a timer node during the traversing, this embodiment provides an update flag of the linked list, which is in turn set to True after the expiration time of the current timer node has been updated. The linked list is updated after the traversing.

S306, delete the current timer node.

Specifically, the current timer node will be simply deleted after the callback function of the timer node is executed if the current timer node is a one-time timer.

S307, set a next timer node in the timer linked list as the current timer node, and return to step S301.

Specifically, after the current timer node has been handled, the traversing continues to a next timer node, performing the above traversing operation on the next timer node.

S308, determine whether the update flag of the linked list is set to be True and, if yes, execute step S309, otherwise, execute step S310.

Specifically, after the traversing of the timer node is completed, the value of the update flag of the linked list may be used in is determining whether there is a timer node whose timing mode is a periodic timer among the processed timer node. If there is a timer node whose timing mode is a periodic timer, the timer linked list will need to be resorted. If there is no timer node whose timing mode is a periodic timer, there is no need to process the timer linked list.

S309, update ordering of the timer linked list.

Specifically, update flag of the linked list being True indicates that a timer node whose timing mode is a periodic timer was processed during the traversing process. Then, the timer linked list is resorted, so that the processed timer node whose timing mode is a periodic timer is inserted into a proper position.

S310, update the counting period of the hardware timer.

Specifically, if the current timer node is empty or the current system time is less than the expiration time of the current timer node, the counting period of the hardware timer is updated after determining the update flag of the linked list. For the specific update method, reference may be made to the method shown in FIG. 2, which will not be repeated herein.

According to the method of timer implementation provided by the present embodiment, the current system time is firstly obtained when traversing through the timer linked list; a timer node that is expired is identified based on the current system time. Therefore, multiple scheduled tasks of timer nodes with similar expiration times can be processed in time to reduce system delay. Moreover, by providing the update flag of the linked list, missing of timer node during the traversing can be avoided, and accuracy of the software timer can be improved.

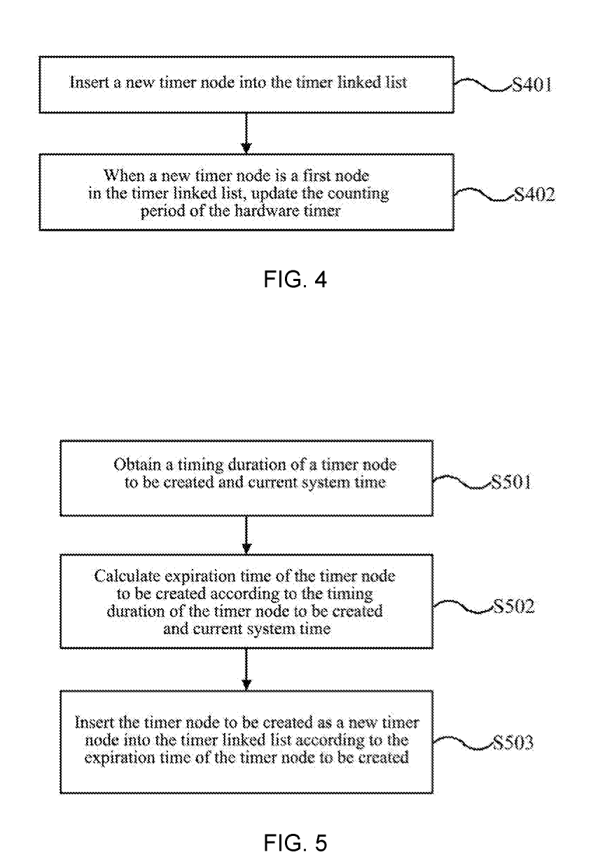

FIG. 4 is a schematic flowchart of still another implementation method of timer provided by the embodiment of the present disclosure. The embodiment serves to detail the process of creating a new timer node in the timer linked list. On the basis of the foregoing embodiments, as shown in FIG. 4, the method provided in the embodiment may further include the following steps.

S401, insert a new timer node into the timer linked list.

Specifically, when the user sets a new scheduled task, a new timer node can be inserted into the timer linked list according to the scheduled task.

FIG. 5 is a schematic flowchart of a method for inserting a new timer node into a timer linked list according to an embodiment of the present disclosure. As shown in FIG. 5, in this embodiment, the process of creating a new timer node may specifically include the following.

S501, obtain a timing duration of a timer node to be created and current system time.

Specifically, a new scheduled task (that is, a timer node to be created) has a timing duration. When a new scheduled task is received, the timing duration and the current system time may be obtained to determine the expiration time of the timer node to be created.

S502, calculate expiration time of the timer node to be created according to the timing duration of the timer node to be created and current system time.

Specifically, the timing duration of the timer node to be created is added to the current system time to obtain the expiration time of the timer node to be created.

S503, insert the timer node to be created as a new timer node into the timer linked list according to the expiration time of the timer node to be created.

Specifically, having determined the expiration time of the timer node to be created, a traversing may begin for the timer node in the timer linked list, so as to insert the timer node to be created as a new timer node into the timer linked list according to its expiration time, such that the expiration time of the new timer node is not less than the expiration time of its previous timer node and not greater than the expiration time of its next timer node.

S402, when a new timer node is the first node in the timer linked list, update the counting period of the hardware timer.

Specifically, when a new timer node is inserted into the timer linked list, it is necessary to determine whether the new timer node is the first timer node and, if yes, the counting period of the hardware timer needs to be updated For the specific manner of the update, one reference may be made to the method shown in FIG. 2, which will not be repeated herein.

According to the method of timer implementation provided in this embodiment, when a new timer node to be created in the timer linked list is the first node in the timer linked list, the counting period of the hardware timer is updated, so as to guarantee the correct order of processing the timer nodes in the timer linked list.

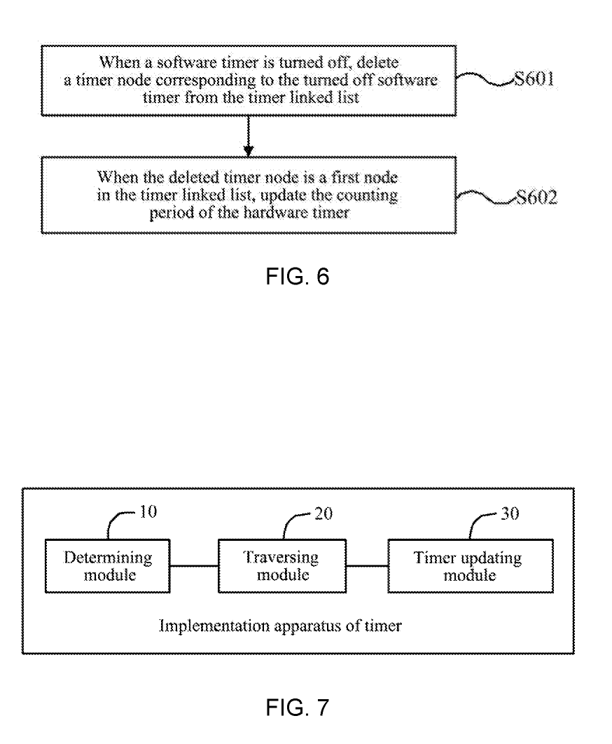

FIG. 6 is a schematic flowchart of still another implementation method of timer provided by the embodiment of the present disclosure. The embodiment describes the process of deleting a timer node from a timer linked list. On the basis of the foregoing embodiments, as shown in FIG. 6, the method provided in this embodiment may further include the following.

S601, when a software timer is turned off, delete a timer node corresponding to the turned off software timer from the timer linked list.

Specifically, when a user turns off a software timer, the scheduled task corresponding to the timer node in the timer linked list is canceled, and the timer node corresponding to the off software timer needs to be deleted.

S602, when the deleted timer node is the first node in the timer linked list, update the counting period of the hardware timer.

Specifically, when a timer node is deleted from a timer linked list, it is necessary to determine whether the deleted timer node is the first timer node and, if yes, the counting period of the hardware timer needs to be updated. For the specific update method, reference may be made to the method shown in FIG. 2, which will not be repeated herein.

According to the method of timer implementation provided by the embodiment, when a timer node being deleted from a timer linked list is the first node in the timer linked list, the counting period of the hardware timer is updated, so as to guarantee the correct order of processing the timer nodes in the timer linked list.

FIG. 7 is a schematic structural diagram of an implementation apparatus of timer according to an embodiment of the present disclosure. As shown in FIG. 7, the apparatus provided by the embodiment includes: a determining module 10, a traversing module 20, and a timer updating module 30, wherein:

the determining module 10 is configured to determine a counting period of a hardware timer according to expiration time of the timer node expires first in a timer linked list;

the traversing module 20 is configured to traverse a timer node in the timer linked list when the counting period of the hardware timer is expired, and instruct the timer updating module 30 to update the counting period of the hardware timer.

As an alternative implementation of the embodiment, each timer node in the timer linked list is sorted according to their expiration time.

The implementation apparatus of timer provided in this embodiment may perform the foregoing method embodiments with a similar implementation principle and technical effects, which will not be repeated herein.

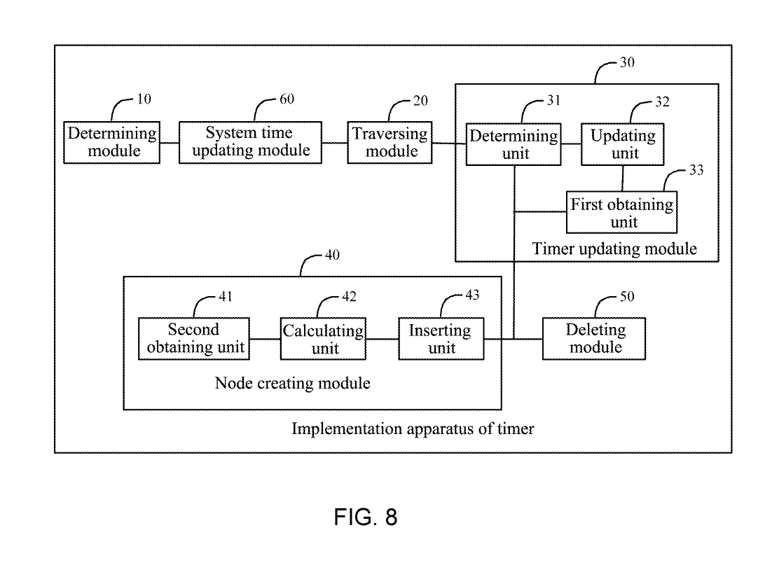

FIG. 8 is a schematic structural diagram of another implementation apparatus of timer provided by the embodiment of the present disclosure. The embodiment is a further optimization and supplement to the embodiment shown in FIG. 7 above. As shown in FIG. 8, in the apparatus provided in the embodiment, the timer updating module 30 includes:

a determining unit 31, configured to determine whether the timer linked list is empty;

an updating unit 32, configured to update the counting period of the hardware timer with the maximum counting period of the hardware timer when the timer linked list is empty; and

a first obtaining unit 33, configured to obtain the expiration time of the timer node expires first in the timer linked list and current system time when the timer linked list is not empty, wherein

the determining unit 31 is further configured to determine whether a time interval between the expiration time of the timer node expires first and the current system time is greater than the maximum counting period of the hardware timer; and

the updating unit 32 is further configured to: when the time interval is greater than the maximum counting period of the hardware timer, update the counting period of the hardware timer with the maximum counting period of the hardware timer; when the time interval is less than or equal to the maximum counting period of the hardware timer, update the counting period of the hardware timer with the time interval.

As an alternative implementation of the embodiment, the traversing module 20 is specifically configured to:

set the first timer node in the timer linked list to be a current timer node, and traverse through the current timer node, the traversing including:

obtaining current system time;

determining whether the current timer node is not empty and the current system time is greater than or equal to the expiration time of the current timer node; and

if the current timer node is empty or the current system time is less than the expiration time of the current timer node, instructing the timer updating module 30 to update the counting period of the hardware timer;

if the current timer node is not empty and the current system time is greater than or equal to the expiration time of the current timer node, executing a callback function of the current timer node;

setting a next timer node in the timer linked list as a current timer node, and returning to the traversing.

Further, the traversing module 20 may further be configured to:

determine whether the current timer node is a periodic timer and,

if the current timer node is a periodic timer, instruct the timer updating module 30 to update the expiration time of the current timer node, and set the update flag of the linked list to be True;

if the current timer node is a one-time timer, delete the current timer node;

the traversing module 20 is further configured to: determine whether the update flag of the linked list is set to be True when the current timer node is empty or the current system time is less than the expiration time of the current timer node, and before the timer updating module is instructed to update the counting period of the hardware timer and,

update the ordering of the timer linked list if the update flag of the linked list is set to be True.

As an alternative implementation of the embodiment, the apparatus may further include:

a node creating module 40, configured to insert a new timer node into the timer linked list, wherein

the node creating module 40 is further configured to, when the new timer node is the first node in the timer linked list, instruct the timer updating module 30 to update the counting period of the hardware timer.

Further, the node creating module 40 may specifically include:

a second obtaining unit 41, configured to obtain a timing duration of a timer node to be created and current system time;

a calculating unit 42, configured to calculate expiration time of the timer node to be created according to the timing duration of the timer node to be created and the current system time; and

an inserting unit 43, configured to insert a timer node to be created as a new timer node into the timer linked list according to the expiration time of the timer node to be created.

As an alternative implementation of the embodiment, the apparatus may further include:

a deleting module 50, configured to delete a timer node corresponding to an off software timer in the timer linked list when the software timer is turned off; and

the deleting module 50 is further configured to: instruct the timer updating module to update the counting period of the hardware timer when the deleted timer node is the first node in the timer linked list.

As another alternative implementation of the embodiment, the apparatus may further include: a system time updating module 60, configured to, when a counting period of a hardware timer expires, update system time with the expiration time of the counting period of the hardware timer before traversing the timer node in the timer linked list.

The apparatus provided in this embodiment may perform the foregoing method embodiments with a similar implementation principle and technical effects, which will not be repeated herein.

Finally, it should be noted that the foregoing embodiments are only used to illustrate the technical solution of the present disclosure, rather than limiting it. Although the present disclosure has been described in detail with reference to the foregoing embodiments, it should be understood by those skilled in the art that the technical solutions described in the foregoing embodiments may be modified, or some or all of the technical features may be replaced by an equivalence, and these modifications or replacements does not cause the essence of the corresponding technical solution to deviate from the scope of the technical solution of various embodiments of the present disclosure.

What is claimed is:

1. An implementation method of timer, comprising:
determining a counting period of a hardware timer according to expiration time of a timer node expires first in a timer linked list; and
when the counting period of the hardware timer is expired, traversing through the timer node in the timer linked list and updating the counting period of the hardware timer.

2. The method according to claim 1, wherein the updating the counting period of the hardware timer comprises:
determining whether the timer linked list is empty and,
if the timer linked list is empty, updating the counting period of the hardware timer with a maximum counting period of the hardware timer;
if the timer linked list is not empty, obtaining the expiration time of the timer node expires first in the timer linked list and current system time;
determining whether a time interval between the expiration time of the timer node expires first and the current system time is greater than the maximum counting period of the hardware timer and,
if the time interval is greater than the maximum counting period of the hardware timer, updating the counting period of the hardware timer with the maximum counting period of the hardware timer;
if the time interval is less than or equal to the maximum counting period of the hardware timer, updating the counting period of the hardware timer with the time interval.

3. The method according to claim 1, wherein each timer node in the timer linked list is sorted according to their expiration time.

4. The method according to claim 3, wherein the traversing through the timer node in the timer linked list and updating the counting period of the hardware timer comprises:
setting a first timer node in the timer linked list to be a current timer node, and performing traversing operation on the current timer node, the traversing operation comprising:
obtaining current system time;
determining whether the current timer node is not empty and the current system time is greater than or equal to the expiration time of the current timer node;
updating the counting period of the hardware timer if the current timer node is empty or the current system time is less than the expiration time of the current timer node;
if the current timer node is not empty and the current system time is greater than or equal to the expiration time of the current timer node, executing a callback function of the current timer node; and
setting a next timer node in the timer linked list to be the current timer node, and returning to perform the traversing operation.

5. The method according to claim 4, wherein, after the executing a callback function of the current timer node, the method further comprises:
determining whether the current timer node is a periodic timer and,
if the current timer node is a periodic timer, updating the expiration time of the current timer node, and setting an update flag of the timer linked list to be True;
if the current timer node is a one-time timer, deleting the current timer node;
when the current timer node is empty or the current system time is less than the expiration time of the current timer node, then before updating the counting period of the hardware timer, the method further comprises:
determining whether the update flag of the timer linked list is set to be True; and
updating ordering of the timer linked list if the update flag of the timer linked list is set to be True.

6. The method according to claim 3, wherein the method further comprises:
inserting a new timer node into the timer linked list; and
when the new timer node is the first timer node in the timer linked list, updating the counting period of the hardware timer.

7. The method according to claim 6, wherein the inserting a new timer node into the timer linked list comprises:
obtaining a timing duration of a timer node to be created and current system time;
calculating expiration time of the timer node to be created according to the timing duration of the timer node to be created and the current system time; and
inserting the timer node to be created as a new timer node into the timer linked list according to the expiration time of the timer node to be created.

8. The method according to claim 3, wherein the method further comprises:
when a software timer is turned off, deleting a timer node corresponding to the turned off software timer from the timer linked list; and
when the deleted timer node is a first node in the timer linked list, updating the counting period of the hardware timer.

9. The method according to claim 1, wherein, when the counting period of the hardware timer is expired and before the traversing through the timer node in the timer linked list, the method further comprises:
updating system time with the expiration time of the counting period of the hardware timer.

10. An implementation apparatus of timer, comprising: a processor and a memory storing instructions thereon, the processor when executing the instructions, being configured to:
determine a counting period of a hardware timer according to expiration time of a timer node expires first in a timer linked list;
traverse through the timer node in the timer linked list, and update the counting period of the hardware timer, when the counting period of the hardware timer is expired.

11. The apparatus according to claim 10, wherein the processor is further configured to:
determine whether the timer linked list is empty;
update the counting period of the hardware timer with a maximum counting period of the hardware timer when the timer linked list is empty;
obtain the expiration time of the timer node expires first in the timer linked list and current system time when the timer linked list is not empty;
determine whether a time interval between the expiration time of the timer node expires first and the current system time is greater than the maximum counting period of the hardware timer; and
update the counting period of the hardware timer with the maximum counting period of the hardware timer when the time interval is greater than the maximum counting period of the hardware timer, and update the counting period of the hardware timer with the time interval when the time interval is less than or equal to the maximum counting period of the hardware timer.

12. The apparatus according to claim 10, wherein each timer node in the timer linked list is sorted according to their expiration time.

13. The apparatus according to claim 12, wherein the processor is further configured to:
set a first timer node in the timer linked list to be a current timer node;
obtain current system time;
determine whether the current timer node is not empty and the current system time is greater than or equal to the expiration time of the current timer node and,
update the counting period of the hardware timer if the current timer node is empty or the current system time is less than the expiration time of the current timer node;
if the current timer node is not empty and the current system time is greater than or equal to the expiration time of the current timer node, execute a callback function of the current timer node; and
seta next timer node in the timer linked list to be the current timer node.

14. The apparatus according to claim 13, wherein the processor is further configured to:
determine whether the current timer node is a periodic timer, and
if the current timer node is a periodic timer, update the expiration time of the current timer node, and set an update flag of the timer linked list to be True; and
if the current timer node is a one-time timer, delete the current timer node.

15. The apparatus according to claim 13, wherein the processor is further configured to:
determine whether the update flag of the timer linked list is set to be True when the current timer node is empty or the current system time is less than the expiration time of the current timer node, and before the counting period of the hardware timer is updated; and
update ordering of the timer linked list if the update flag of the timer linked list is set to be True.

16. The apparatus according to claim 12, wherein the processor is further configured to:
insert a new timer node into the timer linked list; and
when the new timer node is the first node in the timer linked list, update the counting period of the hardware timer according to expiration time of the new timer node.

17. The apparatus according to claim 16, wherein the processor is further configured to:
obtain a timing duration of a timer node to be created and current system time;
calculate expiration time of the timer node to be created according to the timing duration of the timer node to be created and the current system time; and
insert the timer node to be created as a new timer node into the timer linked list according to the expiration time of the timer node to be created.

18. The apparatus according to claim 12, wherein the processor is further configured to:
when a software timer is turned off, delete a timer node corresponding to the turned off software timer from the timer linked list; and
when the deleted timer node is a first node in the timer linked list, update the counting period of the hardware timer.

19. The apparatus according to claim 10, wherein the processor is further configured to: when the counting period of the hardware timer is expired and before the timer node in the timer linked list is traversed through, update system time with the expiration time of the counting period of the hardware timer.

20. The apparatus according to claim 10, wherein the processor is further configured to: update the counting period of the hardware timer according to an expiration time of a timer node next to the timer node expires first in the timer linked list.
